(19) United States
(12) Patent Application Publication
(10) Pub. No.: US 2020/0062056 A1
(43) Pub. Date: Feb. 27, 2020

(54) Universal mounted receiver hitch pin /fast latch pin

(71) Applicant: Gary Corns, Vaceburg, KY (US)

(72) Inventor: Gary Corns, Vaceburg, KY (US)

(21) Appl. No.: 15/207,940

(22) Filed: Jul. 12, 2016

Related U.S. Application Data
(60) Provisional application No. 62/231,689, filed on Jul. 13, 2015.
(60) Provisional application No. 62/282,141, filed on Jul. 25, 2015.

(51) Int. Cl. B60D 1/02; B60D 1/36

(52) U.S. Cl. CPC B60D 1/02; B60D 1/36

(57) ABSTRACT

A universal mounting spring locking receiver hitch pin/fast latch pin which contains a self-locking receiver pin with two bolts configured to be bolted on trailer hitches. The universal mounting hitch may attach to a trailer hitch and provide quick and easy attachment to a trailer. The universal mounting hitch comprises a housing with a pin and spring disposed therein. The universal mounting hitch may be attached to a trailer hitch such that the pin is aligned with a hole in the trailer hitch and the pin may quickly move through and retract from the trailer hitch without becoming completely unattached from the housing.

### RELATED APPLICATION

This application claims priority to Provisional Patent Application No. 62/231,689, filed Jul. 13, 2015, and U.S. Provisional Patent Application No. 62/282,141, filed Jul. 25, 2015, the disclosures of which are incorporated herein by reference.

### BACKGROUND

Embodiments of the invention relate to hitches for attaching trailers to vehicles. Specifically, embodiments of the invention relate to a universal mounting hitch with a fast latching pin.

### RELATED ART

Typical trailer hitches secure trailers to vehicles. What is needed is a universal mounting hitch that allows securing pins to be constantly maintained in a ready position and to be securely inserted with ease and in a minimal amount of time through the trailer hitch.

### BRIEF DESCRIPTION OF THE DRAWING FIGURES

FIG. 1 depicts a perspective view of an embodiment of a universal mounting hitch;

FIG. 2 depicts a side view of the universal mounting hitch presented in

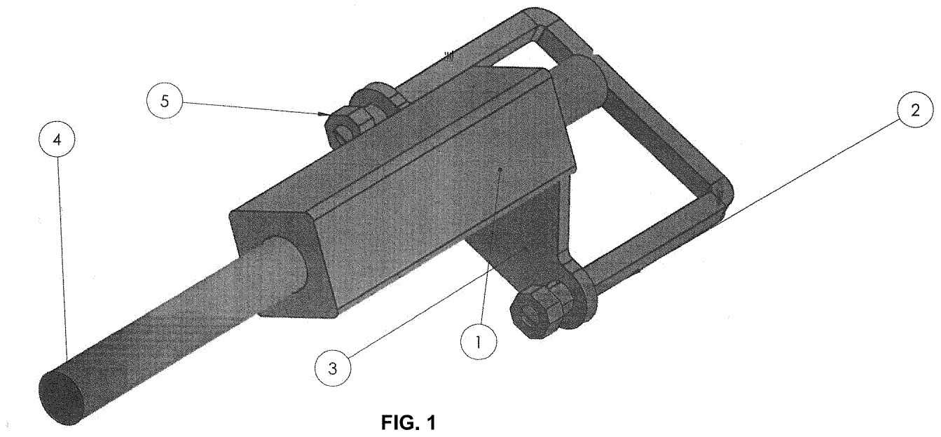

FIG. 1;

FIG. 3 depicts a front view of the universal mounting hitch; and

FIG. 4 depicts a rear view the universal mounting hitch.

### DETAILED DESCRIPTION

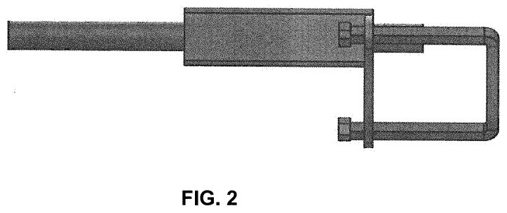

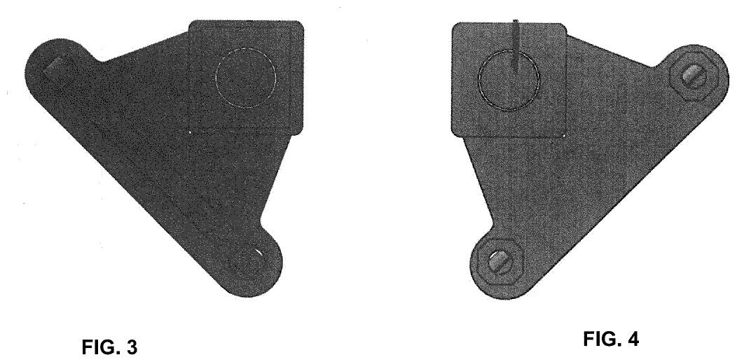

FIGS. 1-4 depict a universal mounting hitch with a fast hitch pin securement and locking mechanism that allows the pins to be constantly maintained in an aligned and ready position. The pins may be securely inserted with ease and in a minimal amount of time through a trailer hitch. In some embodiments, the universal mounting hitch may be mounted to the trailer hitch allowing quick attachment of a trailer to the trailer hitch. The universal mounting hitch may be attached to any standard 2 inch truck hitch. Alternatively, in some embodiments, the universal mounting hitch may be sized to fit bigger trailer hitches. In some embodiments, the universal mounting hitch comprises at least a housing 1, a U-bolt 2, a tube plate 3, a pin 4, and fastening nuts 5 as depicted in FIGS. 1-4.

The housing 1 may house a spring (not shown) and at least a portion of the pin 4. The pin 4 may slide through the housing 1 and, in some embodiments, be configured with a pull handle (not shown). In some embodiments, the pin 4 may be 6.5 inches long and ⅝ inches in diameter. In some embodiments, when the pin 4 is secured through the trailer hitch a pull pin or clip (not shown) is used to secure the pin 4 in place.

The housing 1 may be attached to the tube plate 3. The tube plate 3 may be configured with a hole for receiving the pin 4 therein. The tube plate 3 may comprise two holes allowing a U-bolt 2 to be secured to the tube plate 3 as shown in FIGS. 1-4.

The U-bolt 2 may be secured to the tube plate 3 with the fastening nuts 5. In some embodiments, the U-bolt 2 may be secured to the trailer hitch such that the pin 4 is aligned with a hole in the trailer hitch for receiving the pin 4. The universal locking hitch may be welded to the trailer hitch. The universal mounting hitch may be attached with fasteners, adhesive, or mechanically affixed to the trailer hitch.

In some embodiments, a spring is disposed in the housing 1 and attached to the pin 4. When the universal mounting hitch is secured to the trailer hitch, the pin 4 may be aligned with a hole in the trailer hitch such that the pin 4 may easily line up and quickly move through and retract from the trailer hitch and the trailer. In some embodiments, the pin 4 may be pulled out and locked.

In some embodiments, there is no spring and the universal mounting hitch may secure the trailer hitch to the trailer by the pin 4. The pin 4 may be aligned with the hole in the trailer hitch and the hole in the trailer and the pin 4 may quickly move through and retract from the trailer hitch.

Having thus described various embodiments of the invention, what is claimed is new and desired to be protected by the Letters Patent includes the following:

1-4. (canceled)

5. A housing device for vehicular trailer hitch pins comprising:
a welded box that is welded to the side of a trailer hitch;
a welded hole patterned in such a way to allow the trailer hitch pin to easily line up and quickly move through and retract from the trailer hitch without becoming completely unattached from the housing device; and
a trailer hitch pin and accompanying clip to completely secure the trailer to the hitch.

6. The housing device for vehicular trailer hitch pin of claim 5 wherein said housing comprises:
a manufactured box that attaches or fastens or adheres or mechanically affixes to the side of a trailer hitch;
a manufactured hole patterned in such a way to allow the trailer hitch pin to easily line up and quickly move through and retract from the trailer hitch without becoming completely unattached from the housing device; and
a trailer hitch pin and accompanying clip to completely secure the trailer to the hitch.

7. The housing device for vehicular trailer hitch pin of claim 5 comprising:
an ⅛×1¼×1½ square steel tubing;
a “W” plate with two 5/16 holes welded to a single end of the tube; and
a plasma cut square cap consisting of a 11/16 hole.
